(19) United States
(12) Patent Application Publication
(10) Pub. No.: US 2024/0091873 A1
(43) Pub. Date: Mar. 21, 2024

(54) SHIELDING GAS EJECTING DEVICE, AND MACHINING DEVICE

(71) Applicant: Nidec Machine Tool Corporation, Ritto, Shiga (JP)

(72) Inventors: Yoshinao KOMATSU, Tokyo (JP); Yoshihito FUJITA, Ritto (JP)

(21) Appl. No.: 18/274,733

(22) PCT Filed: Jan. 28, 2022
(86) PCT No.: PCT/JP2022/003360

§ 371 Date: Jul. 28, 2023

(30) Foreign Application Priority Data
Jan. 29, 2021 (JP) 2021-013504

(51) Int. Cl. B23K 9/32; B23K 26/14

(52) U.S. Cl. CPC B23K 9/325; B23K 26/1476; B33Y 30/00

(57) ABSTRACT

A shielding gas ejecting device includes a nozzle body extending along an axis, an inner shielding gas ejection path provided inside the nozzle body and opened on the axis, an outer shielding gas ejection path surrounding the inner shielding gas ejection path from a periphery, and an intermediate shielding gas ejection path provided between the inner shielding gas ejection path and the outer shielding gas ejection path. A flow velocity of an intermediate shielding gas ejected from the intermediate shielding gas ejection path is lower than a flow velocity of an inner shielding gas ejected from the inner shielding gas ejection path and a flow velocity of an outer shielding gas ejected from the outer shielding gas ejection path.

### CROSS REFERENCE TO RELATED APPLICATION

This is a U.S. national stage of application No. PCT/JP2022/003360, filed on Jan. 28, 2022, and claiming priority to Japanese Patent Application No. 2021-013504, filed in Japan on Jan. 29, 2021, the entire contents of which are hereby incorporated herein by reference.

### 1. FIELD OF THE INVENTION

The present disclosure relates to a shielding gas ejecting device and a machining device.

### 2. BACKGROUND

For example, in a machining device including an additive manufacturing device or a buildup welding device, it is necessary to prevent oxidation caused by contact of a base material (workpiece) with air. Therefore, these machining devices are provided with a mechanism for supplying the shielding gas to the surface of the base material. A device that ejects shielding gas from the periphery of a laser irradiation unit is known as this type of mechanism. A configuration in which the base material is protected by directly blowing shielding gas from an annular nozzle opening onto the surface of a base material is also known.

Here, when the shielding gas is blown onto the surface of the base material as described above, the shielding gas forms a layer that flows spreading outward on the surface of the base material. On the other hand, a circular vortex is generated by being dragged by the flow of the shielding gas inside this layer. Such circular vortex causes fluctuation in the flow of the shielding gas. As a result, the shielding gas layer is locally or intermittently broken, and there is a possibility of failing to obtain a sufficient shielding effect.

### SUMMARY

A shielding gas ejecting device according to an example embodiment of the present disclosure includes a nozzle body extending along an axis, an inner shielding gas ejection path provided at a top end of the nozzle body and opened annularly about the axis, an outer shielding gas ejection path surrounding the inner shielding gas ejection path from a periphery, and an intermediate shielding gas ejection path provided between the inner shielding gas ejection path and the outer shielding gas ejection path. A flow velocity of an intermediate shielding gas ejected from the intermediate shielding gas ejection path is lower than a flow velocity of an inner shielding gas ejected from the inner shielding gas ejection path and a flow velocity of an outer shielding gas ejected from the outer shielding gas ejection path.

The above and other elements, features, steps, characteristics and advantages of the present disclosure will become more apparent from the following detailed description of the example embodiments with reference to the attached drawings.

### BRIEF DESCRIPTION OF DRAWINGS

FIG. 1 is a longitudinal cross-sectional view of a shielding gas ejecting device according to a first example embodiment of the present disclosure.

FIG. 2 is a longitudinal cross-sectional view of a shielding gas ejecting device according to a second example embodiment of the present disclosure.

FIG. 3 is a view illustrating a variation of a nozzle body according to the second example embodiment of the present disclosure, and is a cross-sectional view of the nozzle body as viewed from the axial direction.

FIG. 4 is an explanatory view illustrating an opening direction of an outer shielding gas ejection path according to the second example embodiment of the present disclosure.

### DETAILED DESCRIPTION

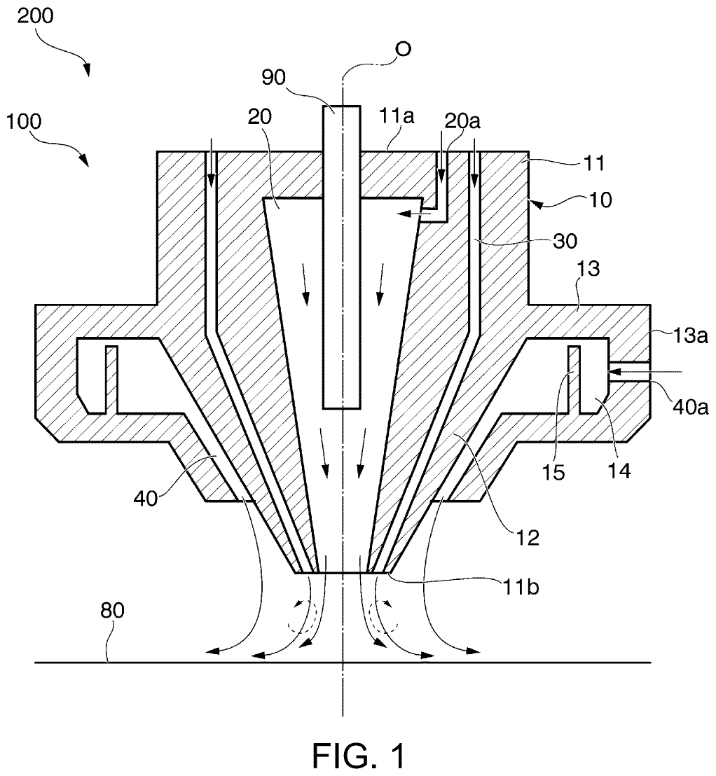

Hereinafter, a machining device 200 and a shielding gas ejecting device 100 according to the first example embodiment of the present disclosure will be described with reference to FIG. 1. The machining device 200 includes a machining assembly 90 and the shielding gas ejecting device 100.

As the machining assembly 90, a device appropriately selected from a plurality of types of devices such as a laser irradiation device for performing additive manufacturing and a welding nozzle for performing buildup welding is applied.

The shielding gas ejecting device 100 is used for ejecting the shielding gas to a machining target object (workpiece 80) by the above-described machining assembly 90 to prevent oxidation or surface deterioration from occurring in the object. The shielding gas ejecting device 100 includes a nozzle body 10, an inner shielding gas ejection path 20, an intermediate shielding gas ejection path 30, and an outer shielding gas ejection path 40.

The nozzle body 10 includes a main part 11, a reduced diameter part 12, a chamber forming part 13, and a partition plate 15. The main part 11 has a columnar shape extending along an axis O. The diameter dimension of the main part 11 is constant over the entire region in the axis O direction. The reduced diameter part 12 is integrally provided below the main part 11 (i.e., the side on which the workpiece 80 is positioned). The reduced diameter part 12 has a tapered shape in which the diameter dimension gradually decreases the upper side toward the lower side.

The chamber forming part 13 is provided on the outer peripheral side of the reduced diameter part 12. The chamber forming part 13 has an annular shape protruding radially outward from the outer peripheral surface of the reduced diameter part 12. A space (chamber 14) is formed inside the chamber forming part 13. This chamber 14 is a space for guiding an outer shielding gas described later. The partition plate 15 is provided inside the chamber 14. The partition plate 15 protrudes upward from an upward-facing surface of the inner surface of the chamber 14 and has an annular shape about the axis O. The chamber 14 is segmented by the partition plate 15 into a region on an outer peripheral side and a region on an inner peripheral side. A gap extending in the axis O direction is formed between the upper end surface of the partition plate 15 and the inner wall of the chamber 14.

The inner shielding gas ejection path 20 extends in the axis O direction over the main part 11 and the reduced diameter part 12 described above. The inner shielding gas ejection path 20 is opened on a lower end surface 11b of the reduced diameter part 12. The opening shape of the inner shielding gas ejection path 20 is circular as an example. The inner shielding gas ejection path 20 has a flow path cross-sectional area gradually decreasing the upper side toward the lower side. The inner shielding gas is supplied to this inner shielding gas ejection path 20 through an inner shielding gas supply path 20a formed on the upper end surface of the main part 11. The above-described machining assembly 90 protrudes inside the inner shielding gas ejection path 20. That is, various types of machining by the machining assembly 90 are performed via this inner shielding gas ejection path 20.

The intermediate shielding gas ejection path 30 extends over the main part 11 and the reduced diameter part 12, and surrounds the inner shielding gas ejection path 20 from the outer peripheral side. That is, the intermediate shielding gas ejection path 30 is formed in the entire region in the circumferential direction about the axis O. An outlet of the intermediate shielding gas ejection path 30 is opened on the lower end surface 11b. This opening has an annular shape about the axis O. In the intermediate shielding gas ejection path 30, a part penetrating the main part 11 extends in the axis O direction, and a part penetrating the reduced diameter part 12 extends in a direction getting closer to the axis O from the upper side toward the lower side. The intermediate shielding gas is supplied to the intermediate shielding gas ejection path 30 from an inlet opening on an upper end surface 11a.

The outer shielding gas ejection path 40 extends downward from the above-described chamber 14. That is, the outer shielding gas ejection path 40 is provided further on the outer peripheral side of the intermediate shielding gas ejection path 30. The outer shielding gas ejection path 40 is formed in the entire region in the circumferential direction about the axis O. The outer shielding gas ejection path 40 extends in a direction getting closer to the axis O from the upper side toward the lower side. The outlet of the outer shielding gas ejection path 40 is positioned upward relative to the lower end surface 11b. The outer shielding gas guided from the chamber 14 flows through the outer shielding gas ejection path 40. This outer shielding gas is supplied to the chamber 14 through an outer shielding gas supply path 40a formed on a side surface 13a of the chamber forming part 13. The outer shielding gas supply path 40a is provided only at one location in the circumferential direction, for example. Note that the outer shielding gas supply paths 40a can be provided at a plurality of locations in the circumferential direction at intervals. The outer shielding gas supplied from the outer shielding gas supply path 40a diffuses in the entire region in the circumferential direction by colliding with the partition plate 15. This allows the outer shielding gas to be ejected in a uniform flow rate distribution in the circumferential direction.

In the shielding gas ejecting device 100 configured as described above, the flow rate and the pressure are adjusted so that the flow velocity decreases in the order of the inner shielding gas, the outer shielding gas, and the intermediate shielding gas. Note that the inner shielding gas, the outer shielding gas, and the intermediate shielding gas may be supplied from the same supply source, and then the flow velocities may be made different as described above by using various valves or the like, or gases having different flow velocities may be supplied from different supply sources.

Next, the operation of the machining device 200 and the shielding gas ejecting device 100 will be described. In operating the machining device 200, first, the shielding gas ejecting device 100 is driven to form a shielding region on the surface of the workpiece 80. Next, the workpiece 80 is subjected to various types of machining by driving the machining assembly 90.

Here, if only the inner shielding gas and the outer shielding gas are blown onto the surface of the workpiece 80, these shielding gases form a layer that flows spreading outward on the surface of the workpiece 80 (solid arrows in FIG. 1). On the other hand, a circular vortex is generated by being dragged by the flow of the shielding gas inside this layer (broken line arrows in FIG. 1). Such circular vortex may cause fluctuation in the flow of the shielding gas. When the flow fluctuates, the shielding is locally broken, and external air flows into the inside of the shielding gas layer. As a result, oxidation or surface deterioration may occur in the workpiece 80.

However, in the above configuration, the intermediate shielding gas ejection path 30 is provided between the inner shielding gas ejection path 20 and the outer shielding gas ejection path 40. When this intermediate shielding gas is ejected, the entrained flow that causes the circular vortex flows out around along with the flow of the intermediate shielding gas. As a result, the circular vortex is less likely to be formed. This can reduce the possibility that the flow of the shielding gas fluctuates. As a result, it is possible to avoid breakage of the shield due to the shielding gas. Therefore, the machining work can be performed more stably.

The flow velocity of the intermediate shielding gas is smaller than the flow velocity of the outer shielding gas or the flow velocity of the inner shielding gas. Therefore, it is also possible to reduce the possibility that the original flow of the outer shielding gas and the inner shielding gas is inhibited by the intermediate shielding gas. This allows the machining operation to be performed more stably.

Furthermore, in the above configuration, the intermediate shielding gas ejection path 30 and the outer shielding gas ejection path 40 are configured to eject the intermediate shielding gas and the outer shielding gas in a direction getting closer to the axis O from the upper side (upstream side) toward the lower side (downstream side). This can form a space more firmly shielded in the region on the workpiece 80 including the axis O by the intermediate shielding gas and the outer shielding gas.

The first example embodiment of the present disclosure has been described above. Note that various changes and modifications can be made to the above configuration without departing from the gist of the present disclosure.

For example, when the shielding gas ejecting device 100 is applied to the additive manufacturing device presented as an example of the machining assembly 90 in the first example embodiment, a supply path for supplying powder to become a material for additive manufacturing can be formed between the inner shielding gas ejection path 20 and the intermediate shielding gas ejection path 30.

A porous plate can also be used as the above-described partition plate 15. Also in this case, the outer shielding gas supplied from the outer shielding gas supply path 40a can be diffused in the circumferential direction, and the outer shielding gas can be ejected in a uniform flow rate distribution.

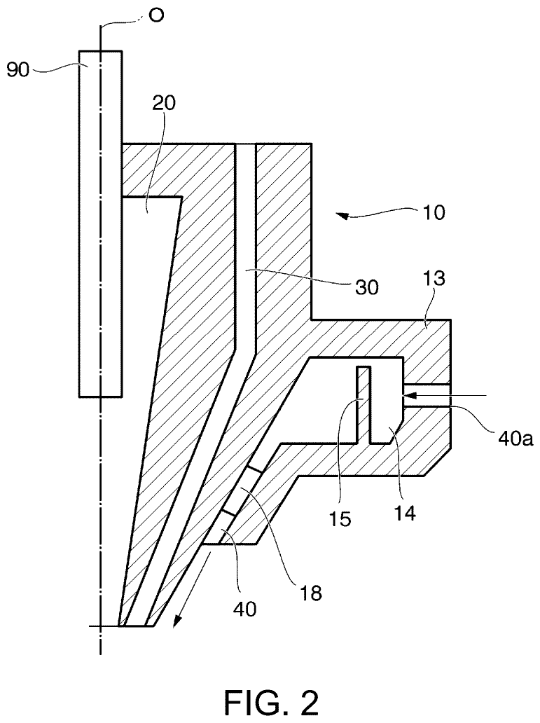

Next, the second example embodiment of the present disclosure will be described with reference to FIG. 2. Note that the same components as those of the first example embodiment are denoted by the same reference signs, and a detailed description will be omitted. As illustrated in the figure, in the present example embodiment, a vane 18 is provided at a middle position of the outer shielding gas ejection path 40. The vane 18 extends from one side to the other side in the circumferential direction the upper side toward the lower side. A plurality of the vanes 18 are arranged at intervals in the circumferential direction. With these vanes 18 being provided, the outer shielding gas ejection path 40 can cause the outer shielding gas to be ejected so as to circle about the axis O.

According to the above configuration, since the outer shielding gas circles about the axis O, the flow direction when the outer shielding gas collides with the workpiece 80 is limited, and the flow field is stabilized. For this reason, the fluctuation amount of the flow of the outer shielding gas from the space on the inner peripheral side toward the outside is reduced. As a result, the flow flowing backward from the outside to the space on the inner peripheral side is reduced, and the shielding performance on the surface of the workpiece 80 can be further improved. As a result, the machining operation can be performed more stably. According to the above configuration, the shielding performance can be improved in a simple structure only by providing the outer shielding gas ejection path 40 with the plurality of vanes 18. This can suppress an increase in cost related to manufacturing and maintenance of the device.

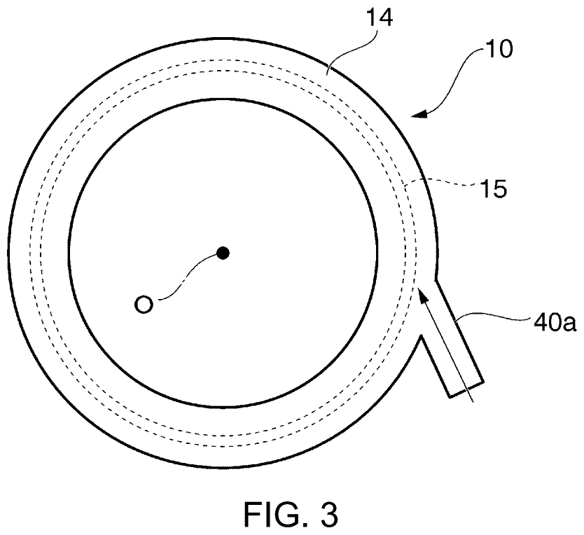

The second example embodiment of the present disclosure has been described above. Note that various changes and modifications can be made to the above configuration without departing from the gist of the present disclosure. For example, as illustrated in FIG. 3, the outer shielding gas supply path 40a (supply flow path) can be configured to extend in a direction having a circumferential component with respect to the axis O. Also in this case, it is possible to cause the outer shielding gas to be ejected so as to circle about the axis O. Note that the example of FIG. 3 illustrates a configuration in which the outer shielding gas supply path 40a is provided only at one location in the circumferential direction. However, it is also possible to provide the outer shielding gas supply path 40a at a plurality of locations in the circumferential direction.

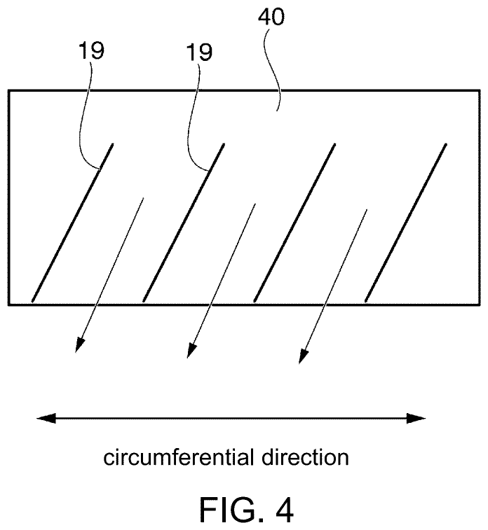

As illustrated in FIG. 4, the outer shielding gas ejection path 40 can be configured to extend from one side to the other side in the circumferential direction from the upstream side toward the downstream side. More specifically, it is possible to adopt a configuration in which a plurality of guide plates 19 are provided at intervals in the circumferential direction at the outlet of the outer shielding gas ejection path 40. These guide plates 19 extend from one side to the other side in the circumferential direction from the upstream side toward the downstream side. Also with this configuration, it is possible to cause the outer shielding gas to be ejected so as to circle about the axis O.

The shielding gas ejecting device 100 described in each example embodiment is understood as follows, for example.

(1) The shielding gas ejecting device 100 according to a first aspect includes: a nozzle body 10 extending along an axis O; an inner shielding gas ejection path 20 formed inside the nozzle body 10 and opened on the axis O; an outer shielding gas ejection path 40 surrounding the inner shielding gas ejection path 20 from a periphery; and an intermediate shielding gas ejection path 30 provided between the inner shielding gas ejection path 20 and the outer shielding gas ejection path 40, in which a flow velocity of an intermediate shielding gas ejected from the intermediate shielding gas ejection path 30 is lower than a flow velocity of an inner shielding gas ejected from the inner shielding gas ejection path 20 and a flow velocity of an outer shielding gas ejected from the outer shielding gas ejection path 40.

Here, if only the inner shielding gas and the outer shielding gas are blown onto the surface of the target object, these shielding gases form a layer that flows spreading outward on the surface of the target object. On the other hand, a circular vortex is generated by being dragged by the flow of the shielding gas inside this layer. Such circular vortex causes fluctuation in the flow of the shielding gas. However, in the above configuration, the intermediate shielding gas ejection path 30 is provided between the inner shielding gas ejection path 20 and the outer shielding gas ejection path 40. When this intermediate shielding gas is ejected, the entrained flow that causes the circular vortex diffuses around along with the flow of the intermediate shielding gas. As a result, the circular vortex is less likely to be formed. This can reduce the possibility that the flow of the shielding gas fluctuates.

(2) In the shielding gas ejecting device 100 according to a second aspect, the intermediate shielding gas ejection path 30 and the outer shielding gas ejection path 40 are configured to eject the intermediate shielding gas and the outer shielding gas in a direction getting closer to the axis O from the upstream side toward the downstream side.

According to the above configuration, it is possible to form a space more firmly shielded in the region including the axis O by the intermediate shielding gas and the outer shielding gas.

(3) In the shielding gas ejecting device 100 according to a third aspect, the outer shielding gas ejection path 40 causes the outer shielding gas to be ejected so as to circle about the axis O.

According to the above configuration, since the outer shielding gas circles about the axis O, the flow direction when the outer shielding gas collides with the target object is limited, and the flow field is stabilized. Therefore, fluctuation of the flow of the outer shielding gas from the space on the inner peripheral side toward the outside is reduced. As a result, the flow flowing backward from the outside to the space on the inner peripheral side is reduced, and the shielding performance can be further improved.

(4) The shielding gas ejecting device 100 according to a fourth aspect further includes a plurality of the vanes 18 provided in the middle of the outer shielding gas ejection path 40 and arrayed in the circumferential direction of the axis O, and the vanes 18 extend from one side to the other side in the circumferential direction from the upstream side toward the downstream side to cause the outer shielding gas to be ejected so as to circle about the axis O.

According to the above configuration, the shielding performance can be improved in a simple structure only by providing the outer shielding gas ejection path 40 with the plurality of vanes 18.

(5) The shielding gas ejecting device 100 according to a fifth aspect further includes the chamber 14 provided in the nozzle body 10 and into which the outer shielding gas is introduced, and a supply flow path 40a through which the outer shielding gas is supplied to the chamber 14, in which the supply flow path 40a extends in a direction having a circumferential component with respect to the axis O to cause the outer shielding gas to be ejected so as to circle about the axis O.

According to the above configuration, the shielding performance can be improved in a simple structure only by extending the supply flow path 40a in the direction having the circumferential component.

(6) In the shielding gas ejecting device 100 according to a sixth aspect, the outer shielding gas ejection path 40 extends from one side to the other side in the circumferential direction from the upstream side toward the downstream side to cause the outer shielding gas to be ejected so as to circle about the axis O.

According to the above configuration, the shielding performance can be improved in a simple structure only by setting the extending direction of the outer shielding gas ejection path 40 to a direction from one side to the other side in the circumferential direction from the upstream side toward the downstream side.

(7) A machining device 200 according to a seventh aspect includes the shielding gas ejecting device 100 and the machining assembly 90 that performs machining on a workpiece via the inner shielding gas ejection path 20.

According to the above configuration, it is possible to stably perform machining on the workpiece with a higher shielding performance.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

1-7. (canceled)

8. A shielding gas ejecting device comprising:
a nozzle body extending along an axis;
an inner shielding gas ejection path provided inside the nozzle body and opened on the axis;
an outer shielding gas ejection path surrounding the inner shielding gas ejection path from a periphery; and
an intermediate shielding gas ejection path provided between the inner shielding gas ejection path and the outer shielding gas ejection path; wherein
a flow velocity of an intermediate shielding gas ejected from the intermediate shielding gas ejection path is lower than a flow velocity of an inner shielding gas ejected from the inner shielding gas ejection path and a flow velocity of an outer shielding gas ejected from the outer shielding gas ejection path.

9. The shielding gas ejecting device according to claim 8, wherein the intermediate shielding gas ejection path and the outer shielding gas ejection path are configured to eject the intermediate shielding gas and the outer shielding gas in a direction located increasingly closer to the axis from an upstream side toward a downstream side.

10. The shielding gas ejecting device according to claim 8, wherein the outer shielding gas ejection path causes the outer shielding gas so as to be ejected so as to circle about the axis.

11. The shielding gas ejecting device according to claim 9, wherein the outer shielding gas ejection path causes the outer shielding gas to be ejected so as to circle about the axis.

12. The shielding gas ejecting device according to claim 10, further comprising:
a plurality of vanes provided in a middle of the outer shielding gas ejection path and arrayed in a circumferential direction of the axis; wherein
the plurality of vanes extend from one side in the circumferential direction to another side in the circumferential direction from an upstream side toward a downstream side to cause the outer shielding gas to be ejected so as to circle about the axis.

13. The shielding gas ejecting device according to claim 11, further comprising:
a plurality of vanes provided in a middle of the outer shielding gas ejection path and arrayed in a circumferential direction of the axis; wherein
the plurality of vanes extend from one side in the circumferential direction to another side in the circumferential direction from an upstream side toward a downstream side to cause the outer shielding gas to be ejected so as to circle about the axis.

14. The shielding gas ejecting device according to claim 10, further comprising:
a chamber provided in the nozzle body and into which the outer shielding gas is introduced; and
a supply flow path through which the outer shielding gas is supplied to the chamber; wherein
the supply flow path extends in a direction including a circumferential component with respect to the axis to cause the outer shielding gas to be ejected so as to circle about the axis.

15. The shielding gas ejecting device according to claim 11, further comprising:
a chamber provided in the nozzle body and into which the outer shielding gas is introduced; and
a supply flow path through which the outer shielding gas is supplied to the chamber; wherein
the supply flow path extends in a direction including a circumferential component with respect to the axis to cause the outer shielding gas to be ejected so as to circle about the axis.

16. The shielding gas ejecting device according to claim 10, wherein the outer shielding gas ejection path extends from one side in a circumferential direction to another side in the circumferential direction from an upstream side toward a downstream side to cause the outer shielding gas to be ejected so as to circle about the axis.

17. The shielding gas ejecting device according to claim 11, wherein the outer shielding gas ejection path extends from one side in a circumferential direction to another side in the circumferential direction from an upstream side toward a downstream side to cause the outer shielding gas to be ejected so as to circle about the axis.

18. A machining device comprising:
the shielding gas ejecting device according to claim 8; and
a machining assembly to perform machining on a workpiece via the inner shielding gas ejection path.

19. A machining device comprising:
the shielding gas ejecting device according to claim 9; and
a machining assembly to perform machining on a workpiece via the inner shielding gas ejection path.

20. A machining device comprising:
the shielding gas ejecting device according to claim 10; and
a machining assembly to perform machining on a workpiece via the inner shielding gas ejection path.

21. A machining device comprising:
the shielding gas ejecting device according to claim 11; and
a machining assembly to perform machining on a workpiece via the inner shielding gas ejection path.
